(19) United States
(12) Patent Application Publication
(10) Pub. No.: US 2010/0275822 A1
(43) Pub. Date: Nov. 4, 2010

(54) HINGE

(76) Inventor: Stephen Jerry Elford, West Midlands (GB)

Correspondence Address: PAUL D. BIANCO;Fleit Gibbons Gutman Bongini & Bianco PL, 21355 EAST DIXIE HIGHWAY, SUITE 115, MIAMI, FL, 33180, US

(21) Appl. No.: 12/676,151

(22) PCT Filed: Sep. 2, 2008
(86) PCT No.: PCT/GB08/50765

§ 371 Date: Jun. 30, 2010

(51) Int. Cl. E05D 3/12; E05F 1/12; E05D 11/10; A47B 3/00

(52) U.S. Cl. 108/115; 16/366; 16/297; 16/362

(57) ABSTRACT

A hinge (10) comprising an elongate base (11) and first and second hinge plates (12, 13) pivotally mounted on said base (11) for carrying hinged structures (21, 22). The base (11) has two parallel spaced holes (14, 15) for receiving two parallel spaced pivot pins (16, 17) that extends at right angles to the length of the base (11) across the width of the base. Each of the hinge plates (12, 13) has an upstanding portion (23) extending in a direction extending along the length of the base (11) and encompassing a part of the perimeter of the base (11). Flange means (24) are provided for fixing the hinge plate (12, 13) to the hinged structures (21, 22). Each hinge plate (12, 13) has two aligned holes (27) that align with one of the holes (14,15) in the base (11) for receiving one of said pivot pins (16, 17) thereby enabling each hinge plate (12, 13) to pivot relative to the base (11) about a respective one of the pivot pins (16 or 17). To enable the hinge (10) to open through 180°, the base (11) has a pair of upstanding flanges (30) that have two parallel spaced holes (31, 32) for receiving pivot pins (40, 43) of two intermediate members (36, 37) that are provided to lift the hinge pins (16, 17) through an arcuate path to clear the top of the base (11).

This invention relates to hinges and in particular to hinges that can be mounted flush to the surface of hinged components. In particular, although not exclusively this invention relates to a bi-fold hinge for carrying two hinged items such as, for example, doors or table leaves, where the hinge is mounted flush to the surface of the hinged items and does not protrude therefrom. There is also a particular need for a bi-fold hinge that has a base part that enables the hinge itself to be mounted on fixed or moveable structures, whilst allowing the hinged items to be freely hinged relative to the base.

In some cases there is a need for a hinge of the type described wherein the movement of both hinge plates of the hinge can be synchronised either by manually moving one of the hinge plates, or by operation of an actuator that is incorporated within the structure of the hinge.

An object of the present invention is to provide a hinge for carrying two hinged items in which the hinge has a base part on which the hinge plates are mounted and is mounted flush to the surface of the hinged items.

A further object of the present invention is to provide a hinge wherein the base part is provided with means that enables the hinge itself to be mounted on fixed or moveable structures whilst allowing the hinged items to be freely hinged relative to the mounting component.

A further object of the present invention is to provide a hinge having a base part that enables the hinge itself to be mounted on fixed or moveable structures and two hinge plates for carrying two hinged items pivotally mounted on the base part wherein there is provided an arm that acts on at least one of the hinge plates to cause the hinge plates to pivot simultaneously about their respective pivots.

According to one aspect of the present invention there is provided a hinge constructed in accordance with any one of the accompanying claims.

According to a further aspect of the present invention there is provided a table incorporating a hinge constructed in accordance with any one of the accompanying claims.

The present invention will now be described by way of example with reference to the accompanying drawings in which:

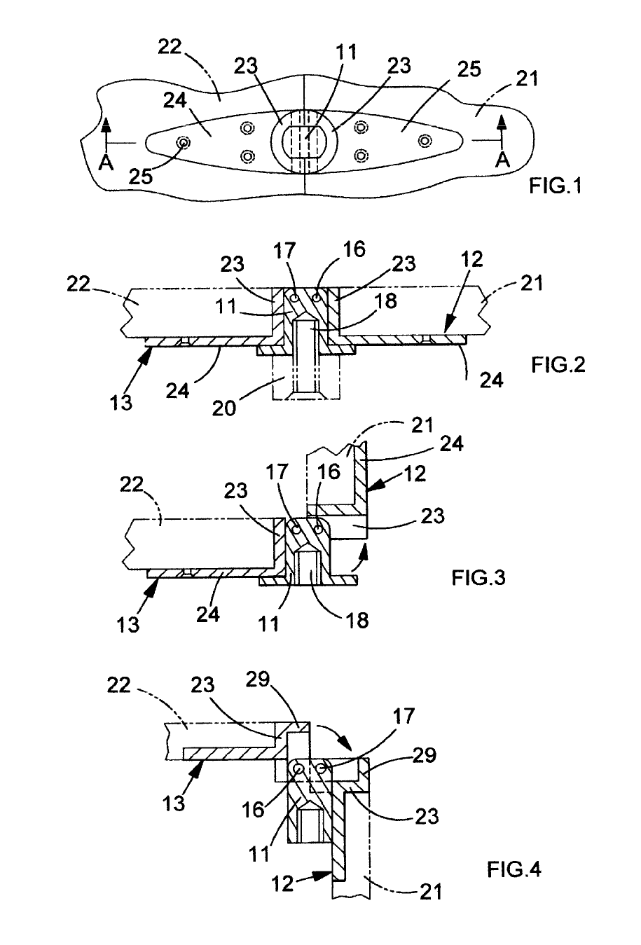

FIG. 1 is a plan view of a hinge constructed in accordance with the present invention;

FIG. 2 is a cross sectional view of the hinge of FIG. 1 taken along the line A-A;

FIG. 3 is a cross-sectional view of the hinge of FIGS. 1 and 2 showing one of the hinged hinge plates open to a 90° position;

FIG. 4 is a cross sectional view of a second hinge constructed in accordance with the present invention:

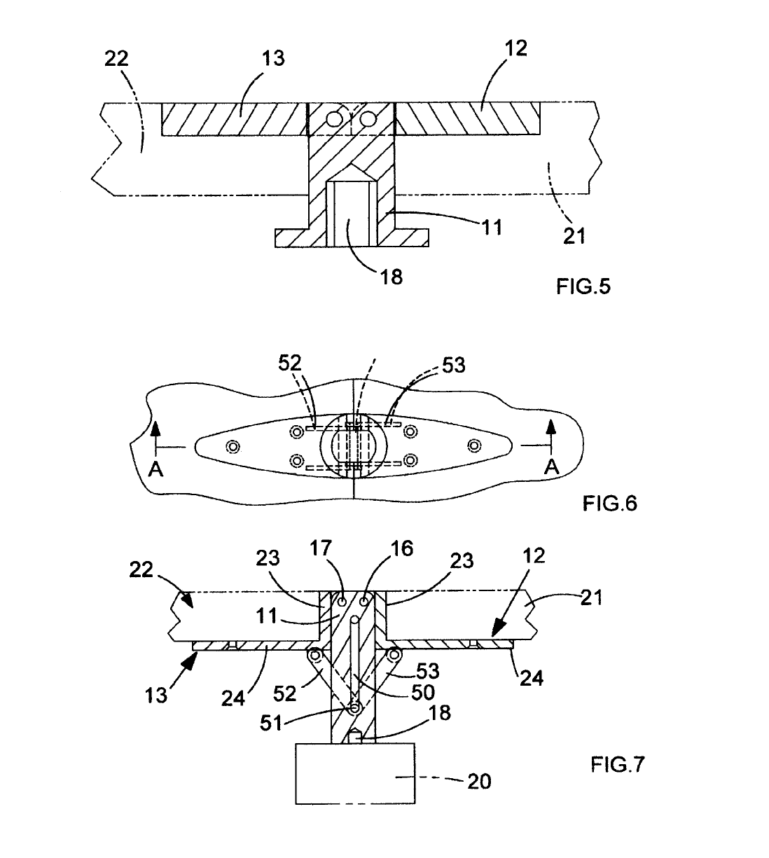

FIG. 5 is a side view of a third hinge constructed in accordance with the present invention;

FIG. 6 is a plan view of a modification of the hinge shown in FIGS. 1 to 3 constructed in accordance with the present invention

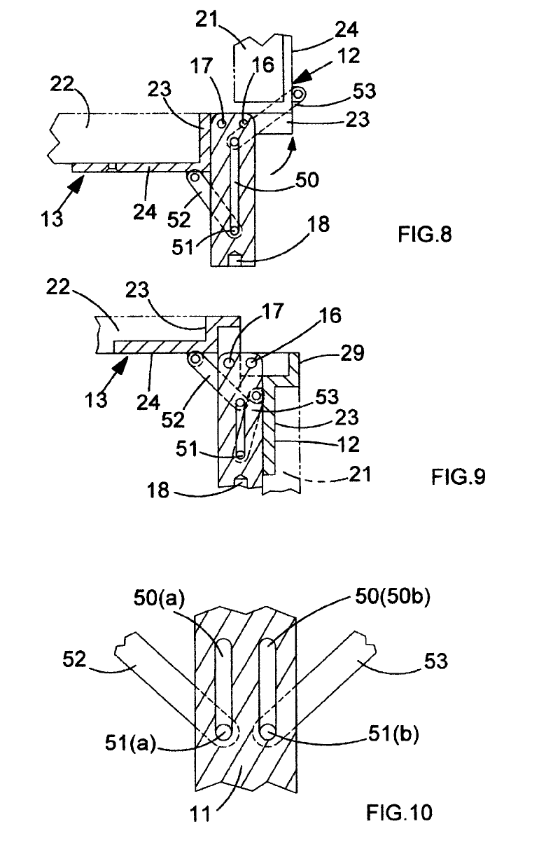

FIGS. 7 and 8 are cross sectional views of the hinge of FIG. 6;

FIG. 9 is a cross sectional view of the hinge of FIG. 4 showing a further modification of the hinge in the form of a single slot and sliding pivot;

FIG. 10 is a cross sectional view of part of the base of the hinges shown in FIGS. 6 to 9 showing a further modification of the hinges in the form of two actuation slots in the base;

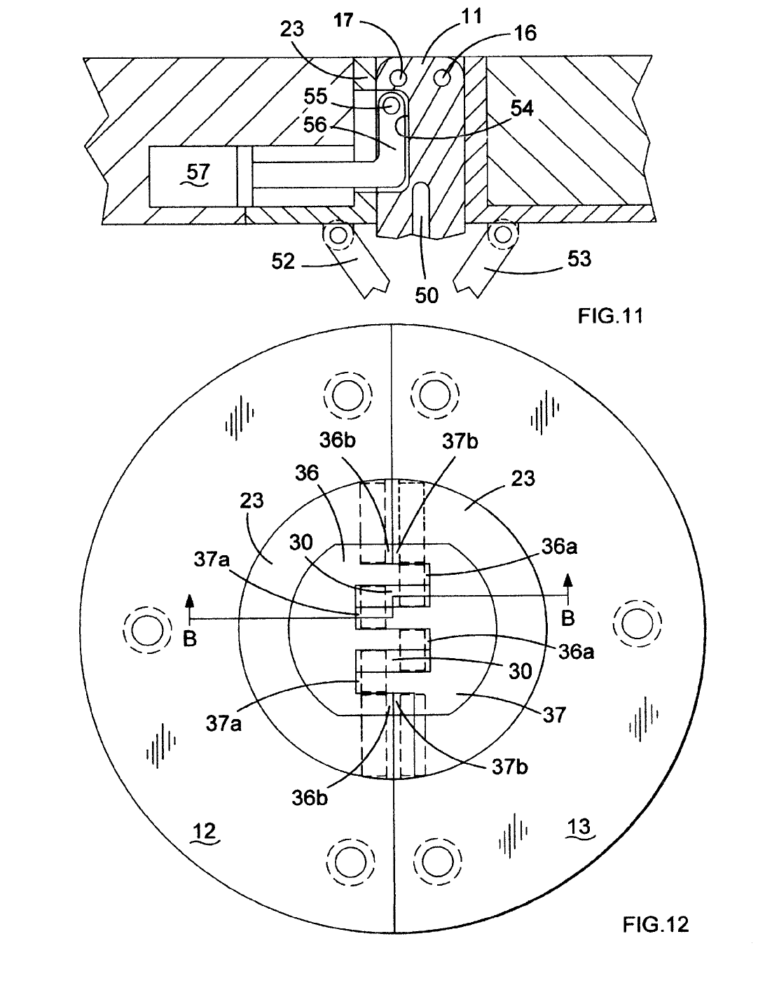

FIG. 11 is a cross sectional view of the hinge of FIGS. 1 to 3 showing a further modification of the hinge of FIGS. 1 to 3 in the form of a cranked lever that acts on the base to move one or more hinge plate;

FIG. 12 is a plan view of a further hinge constructed in accordance with the present invention;

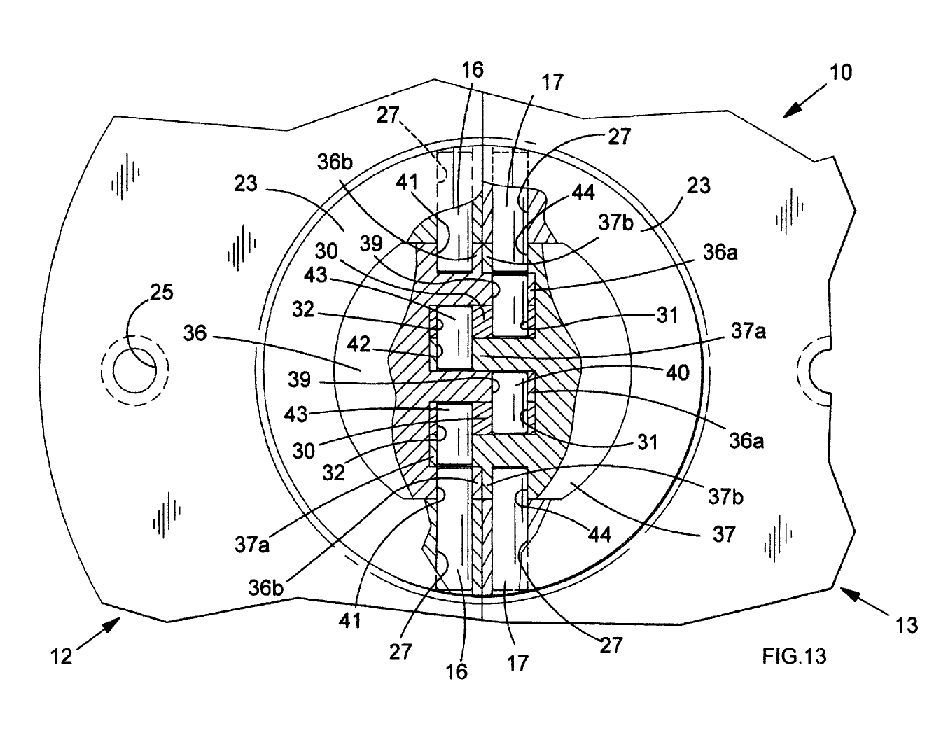

FIG. 13 is a part cross-sectional plan view of the hinge of FIG. 12 taken along a horizontal line through the centres of the hinge pins.

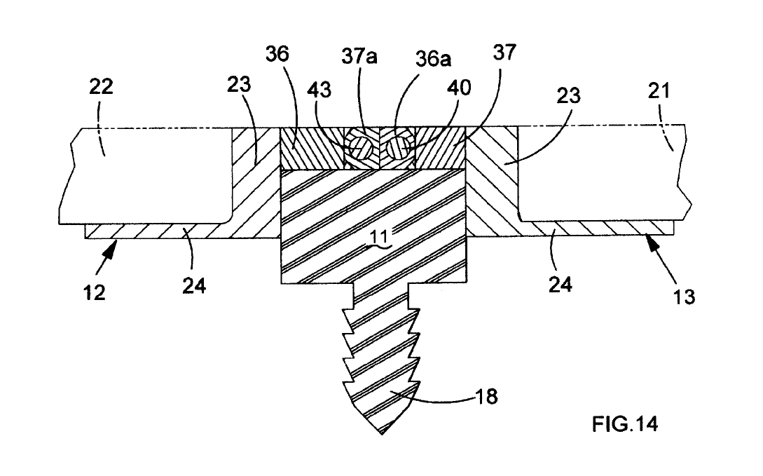

FIG. 14 is a cross sectional side view of the hinge shown in FIGS. 12 and 13;

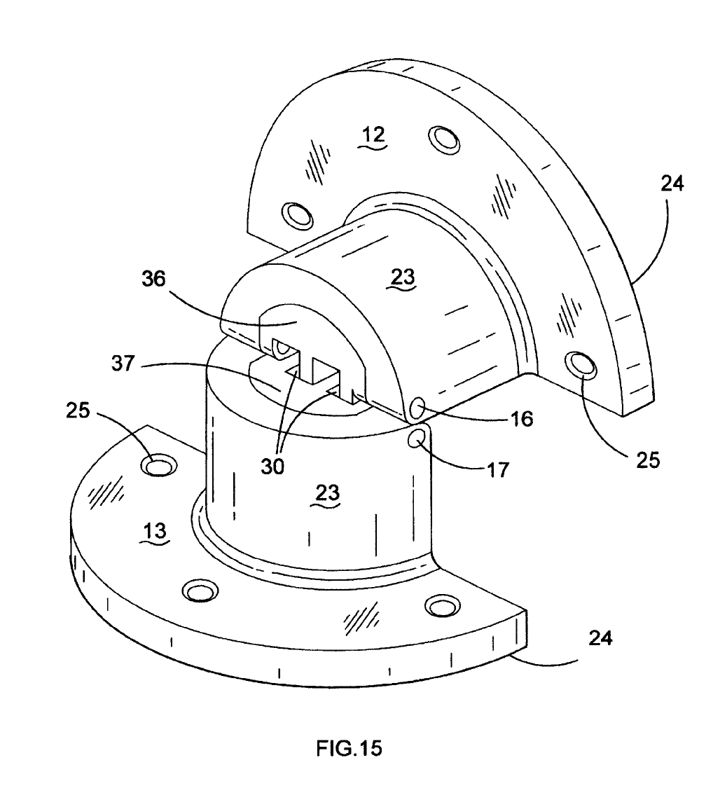

FIG. 15 shows a perspective view of the hinge of FIGS. 12 to 14 showing one of the hinge plates opened to a 90° position;

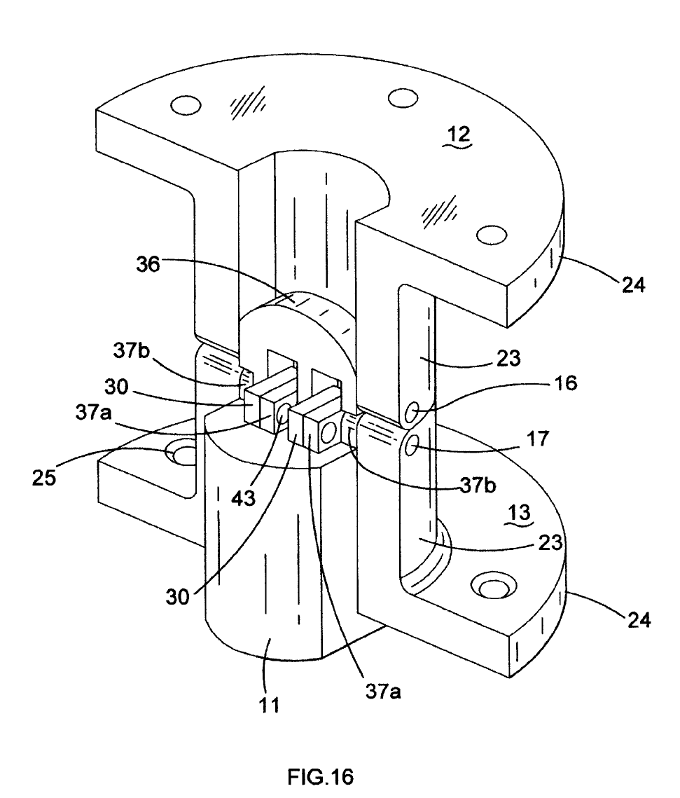

FIG. 16 is a cross-sectional view of the hinge shown in FIGS. 12 to 14 showing one of the hinged hinge plates opened to a 180° position;

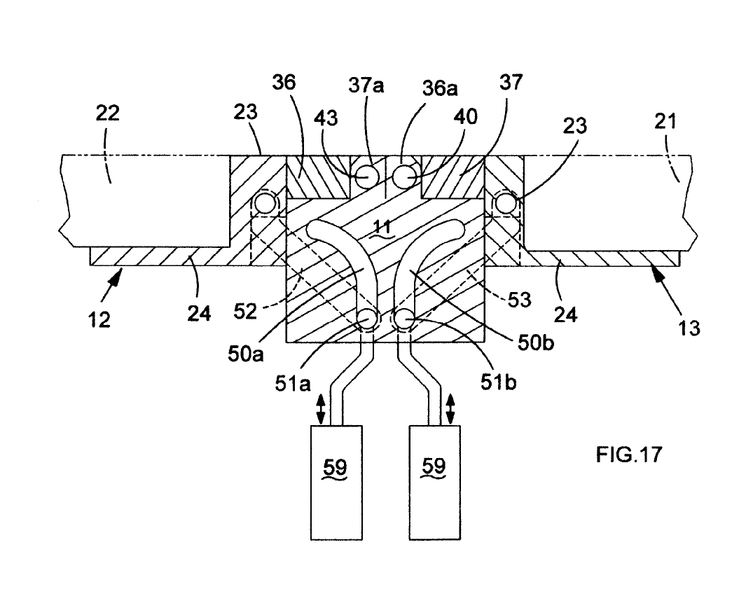

FIG. 17 is a cross sectional view of the hinge of FIGS. 12 to 16 showing a further modification of the hinge in the form of two slots and sliding pivots in the base;

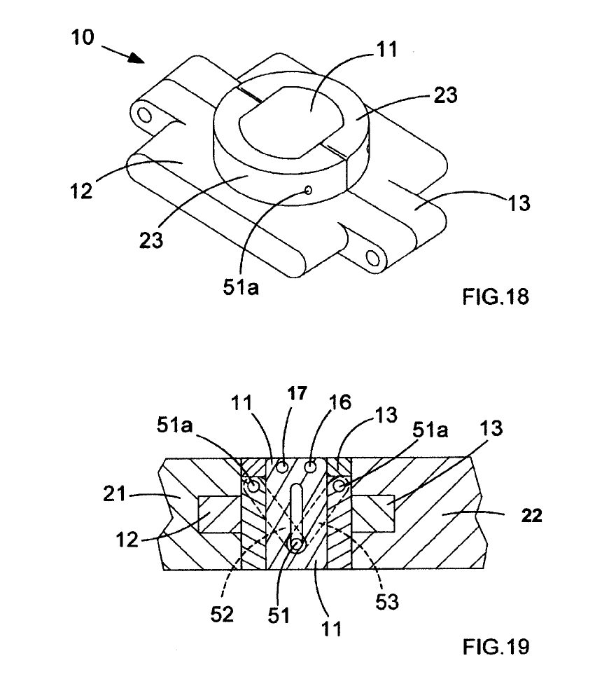

FIGS. 18 and 19 show a further hinge constructed in accordance with the present invention;

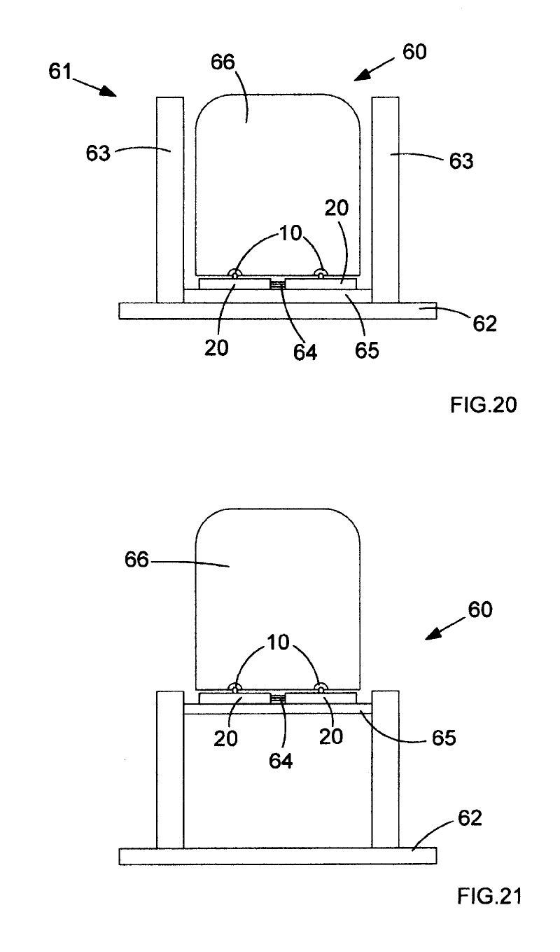

FIGS. 20 to 23 show a folding table with two folding leaves incorporating two hinges of the type shown in any one of FIGS. 1 to 19; and

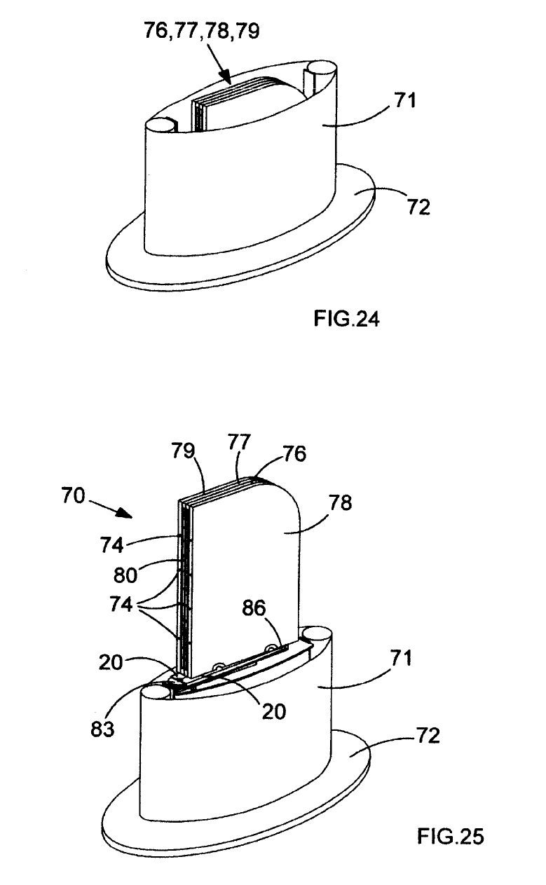

FIGS. 24 to 27 show a second four leaf tab and audio console incorporating hinges of the type shown in any one of FIGS. 1 to 19.

Referring to FIGS. 1 to 3 there is shown a hinge 10 that has a central base 11 in the form of an elongate pillar, and two hinged hinge plates 12, 13 pivotally mounted on the base 11. The base 11 has a small chamfer or radius at its top edge, and two spaced parallel holes 14, 15, for receiving two hinge pins 16, 17 that define first and second pivots. The holes 14, 15 are as close to the centreline and the top surface of the base 11 as possible without the holes breaking through. The cross-sectional shape of the base 11 is generally circular with two diametrically opposed flat surfaces, but could be of the different shapes such as for example, generally rectangular, square or oval.

The base 11 has a fixing means 18 for fixing the hinge 10 to a fixed or movable base structure 20. The fixing means is in the form of a screw threaded bore 18 for receiving a screw threaded screw 19 (as shown in FIG. 2) or stud (not shown), for mounting the hinge 10 fixed or moveable structure 20. The fixing means 18 could be in the form of, for example, a spigot with a “Fir Tree” or ratchet fixing (see FIG. 12) for insertion into a close fitting bore (not shown).

The base structure 20, could be virtually anything, and does not form part of the present invention. Examples of fixed base structures 20 are a fixed wall, an items of furniture structural furniture such as a cabinet, a wall unit, or a carcase (such as that of a kitchen floor or wall unit). Examples of movable structures are operating levers or push rods on which the hinge 10 is mounted that enable the hinge to be moved bodily through a space.

The hinged hinge plates 12, 13 are for fixing hinged structures 21, 22 (shown in dotted outline), such as doors, table flaps, or other structures, that are required to pivot about the hinge pins 16 or 17.

Each hinge plate 12, 13, has an elongated portion 23, extending in a direction along the centreline axis of the base 11 and a flange 24, that extends normal to the portion 23. The portion 23 is of our arcuate shape that has a profile that faces the base that is of complimentary shape to the cross-sectional shape of the base 11 against which it abuts. In the instance where the central base in 11 is of circular cross-section with two flat surfaces (as shown in FIG. 1), the profile of the portion 23 that faces the base 11 is approximately semicircular with two flat surfaces. That is to say, that the portion 23 wraps around approximately one half of the perimeter of the base in 11. The two portions 23 about each other in a plane through the centreline axis of the base 11.

The height of the base 11 and the height of the portion 23 (that is to say the distance between the flange 24 and the end of portion 23) is chosen to match the thickness of the structure carried by the flange 24 so that the surfaces of the structures 21 22 are flush with the end of the portions 23 and base 11 when in the position shown in FIG. 2.

Each hinge plate, 12, 13 has countersunk holes 25 for receiving countersunk screws (not shown) for fixing the hinge plates 12, 13 to the respective structure 21, or 22. Here again, the structure 21, 22 does not form part of the hinge 10. Each portion 23 is provided with two aligned holes 27 that align respectively with the either hole 14, or hole 15 in the base 11 for receiving the hinge pins 16, 17 respectively.

In operation of the hinge 10 of FIGS. 1 to 3, each of the hinge plates 12, 13 can be pivoted about its respective first or second pivot 16 or 17 from a first position (shown in FIG. 2), where the structure 21 or 22 that is attached to the respective hinge plate 12 or 13 lie with their surfaces flush with each other in the same plane, to a second position (shown in FIG. 3) where the structures 21, 22 lie folded alongside each other.

The hinge of FIGS. 1 to 3 provides a flush mounted hinge, with the flanges 24 of the hinge plates 12, 13 fixed to the underside, or the back of the structure 26. In a modification of the version of the hinge shown in FIGS. 1 to 3, the flanges 24 of the hinge plates 12, 13 could be provided at the top of portion 23, flush with the end of the base 11 and the pivots 16, 17 could be positioned at the free end of the base 11. This modified version of hinge 10 is shown in FIG. 4.

Referring to FIG. 4 there is shown a hinge 10 where the base 11 is shortened and terminates below the top surface of the structures 21, 22 when they are in the first position (the cross section shown to the left of the centreline). The portion 23 extends to both sides of the hinge plates 12, 13 and has a recess 23(a) on the side beneath the hinge plates to accommodate the base 11 when the structures 21, 22 of the hinge are lowered to a second position (right side of FIG. 4). The pivots 16, 17 in FIG. 4 are positioned further down portion 23 than those shown in FIG. 2 so that they are roughly just below, the underside of the structures 21, 22.

Whereas the structures 21, 22 of FIGS. 1 to 3 can be raised from the second position (shown in FIG. 2) to the first position (FIG. 3) the doors 21, 22 of the hinge of FIG. 4 are lowered from the first position where the doors are flush (left side of FIG. 3) to the second position (right side of FIG. 4).

The hinge of FIGS. 1 to 3 provides a flush hinge when the structures 21, 22 are in the first position (shown in FIG. 2), whereas the hinge 10 of FIG. 4 would have a hole visible above the base 11 when the structures 21, 22 are in the first position (shown to the left of the centreline in FIG. 4).

There are two possible solutions for closing the hole above the base 11. In the version shown in FIG. 4 the flanges 12, 13 come together at the top and form effectively a blanking plate 29 at the top end of the portion 23 to close off the hole that would otherwise be formed above the base 11. In an alternative version of the hinge of FIG. 4 (not shown), those parts of the portions 23, above the base when the hinge plates 12, 13 are in the position shown to the left of the centreline of FIG. 4, could be solid and of semicircular cross sectional shape to close off the hole that would otherwise be formed above the base 11. In this instance, when both of the hinge plates are raised to the first position the portions 23 abut each other in a plane lying across the diameter of the base in 11.

Referring to FIG. 5, there is shown a hinge 10 which is similar to that shown in FIGS. 1 to 3 but differs from that of FIGS. 1 to 3 in that the flanges 24 of the hinge plates 12, 13 are positioned near the free end of the base 11 for mounting on the top surfaces of the structures 21, 22, and the portions 23 can be made much shorter, or even eliminated (as shown in FIG. 5). In this hinge 10, the holes 14, 15 and hinge pins 16, 17 pass trough the flanges 24 of the hinge plates 12, 13. The flanges 24 are not hidden from view as is the case of the hinges of FIGS. 1 to 4.

Referring to FIGS. 6 to 8 there is shown the hinge of FIGS. 1 to 3 further modified by the provision of a slot 50 in one, or both, flat surfaces of the base 11. Located in the slot 50 is a third pivot 51 that is constrained to slide along the slot 50. Pivotally mounted on the third pivot 51 are two arms 52, 53. Each of the arms 52, 53 is pivotally connected to one of the hinge plates 12, 13.

In operation of the hinge 10 of FIGS. 6 to 8, each of the hinge plates 12, 13 pivots about its respective first or second pivot 16 or 17 from a first position (shown in FIG. 7, where the structure 21 or 22 that is attached to the respective hinge plate 12 or 13 lie with their surfaces flush with each other in the same plane, to a second position (shown in FIG. 8) where the structures 21, 22 lie folded alongside each other. By lifting one of the hinged structures 21 or 22 relative to the base 11, the arm 52 or 53 attached to the hinge plate that is lifted, pulls the third pivot 51 upwards causing the third pivot 51 to push up the other arm 52, or 53, and thereby push up the other hinged structure 21 or 22 in synchronism with the lifted hinge plate 12 or 13.

The hinge of FIGS. 4 and 5 can be similarly modified by the provision of a slot 50 in one or both flat surfaces of the base 11. The modification of the hinge of FIG. 4 is shown in FIG. 9. Referring to FIG. 9, located in the slot 50 is a third pivot 51 that is constrained to slide along the slot 50. Pivotally mounted on the third pivot 51 are two arms 52, 53. Each of the arms 52, 53 is pivotally connected to one of the hinge plates 12, 13.

FIG. 10 shows a further modification of any one of the hinges shown in FIGS. 6 to 9 where the third pivot 51 is replaced by two discrete pivots 51(a) and 51(b) as shown. In this modification there are two discrete slots 50(a), 50(b) in which the pivots 51(a), 51(b) slide. Each arm 52, 53 is attached to one of the hinge plates 12, or 13 as described above. In this way, one hinge plate 12 or 13 can be moved independently of the other hinge plate 12 or 13, or both can by moved in synchronism.

Referring to FIG. 11 there is shown a further modification of the hinge of FIG. 7 (although the modification can also be applied to the hinge shown in FIGS. 1 to 8 as well). The base 11 is provided with a further slot or slots 54 in which is provided a pivot 55 on which is mounted a cranked actuator lever 56. The lever 56 is driven by an actuator 57 mounted in one of the hinged items or on one of the hinge plates 13

The upstanding portion 23 of the hinge plates 12, 13 is also cut away to allow pivotal movement of the, or each, lever 56 about the pivot 55.

The lever 56 is cranked so that it does not foul on the upstanding portion 23 of the hinge plates 12, 13. Actuation of the actuator 57 pushes the lever 56 on to the base 11 and causes the hinge plate 13 to be pushed in a direction away from the base 11, thus causing it to rotate around the respective pivot pin 16 or 17.

Although only one slot 54, one pivot 55, one actuator 57 and one lever 56 is shown in FIG. 11, it is to be understood that there may be two slots 54, two pivots 54, two levers 56 and two actuators 57. In this latter case each of the hinge plates 12, 13 may be provided with an actuator 57.

Referring to FIGS. 12 to 17, there is shown a hinge 10 in which the hinge plates 12, 13 can be swung through an angle of 90° from a first position (shown in FIGS. 12 and 14) to a second position shown in FIG. 15 and on to a third position shown in FIG. 16 which is at 180° to the original position of FIG. 12. Whilst both hinge plates, 28, 30, can be swung is simultaneously through 90° (the position shown in FIG. 15), only one of the hinge plates at a time can be swung through 180° ((the position shown in FIG. 16).

The hinge 10 of FIGS. 12 to 17 comprises a central base 11 similar to that of FIGS. 1 to 3 but modified to have two upstanding spaced flanges 30 projecting from the end of the base 11. The flanges 30 have two parallel spaced aligned holes 31, 32 (see FIG. 16) for receiving hinge pins as will be explained later. The base 11 has a spigot 18 (see FIG. 14) that has a “fir Tree” fixing for insertion into a bore (not shown) in a fixed or moveable structure 20 as explained above in relation to FIGS. 1 to 3.

The hinge plates 12, 13 of the hinge 10 of FIGS. 12 to 17 are very similar to those of the hinge 10 of FIGS. 1 to 3 in that each hinge plate 12, 13 has an upstanding portion 23 which, in a first position of the hinge plate 12, 13 is a close fit to the base 11 and has a flange 24 normal to the portion 23 for fixing to structure 21. Each upstanding portion 23 has two aligned holes 27 (see FIG. 16) near the top end of portion 23 for receiving hinge pins 16, 17 as will be explained in detail later.

The hinge 10 of FIGS. 12 to 17 is provided with two, almost identical, intermediate members 36, 37. Intermediate member 36 has a body with two long fingers 36(a) that extend across the centreline axis of the base and two short fingers 36(b) that terminate on the centreline axis. Similarly the intermediate member 37 has two long fingers 37(a) that extend across the centreline axis of the base 11 and two short fingers 37(b) that terminate on the centreline axis. The intermediate members 36, 37 are assembled with the fingers 36(a), 36(b), 37(a), and 37(b) interdigitated with the each other and with the upstanding spaced flanges 30 of the base 11 (see FIG. 16).

Referring to FIG. 13 the long fingers 36(a) of the member 36 have aligned holes 39 at their free ends that are coaxially aligned with the holes 31 in the flanges 30 of the base 11 and hinge pins 40 are inserted into the holes 31 and 39. The short fingers 36(b) of the member 36 have aligned holes 41 that are coaxially aligned with the holes 27 in the upstanding portion 23, and with the holes 32 in the flanges 30 of the base 11. Two hinge pins 16 are inserted into respective holes 27 in portion 23 and the holes 41 in the short fingers 36(b).

The long fingers 37(a) of the member 37 have holes 42 at their free ends that are coaxially aligned with the holes 32 in the flanges 30 of the base 11 and hinge pins 43 are inserted into the holes 32 and 42. The short fingers 37(b) of the member 37 have holes 44 that are coaxially aligned with the respective holes 27 in the upstanding portion 23 and with the holes 32 in the flanges 30 of the base 11. Two hinge pins 17 are inserted into the aligned holes 27 of the respective portion 23 and holes 44.

In order to achieve movement of each hinge plate 12 or 13 through 180° it is advantageous to provide slightly more resistance to the pivotal movement of the intermediate members 36, 37 about their hinge pins 16, 17 and less resistance to the pivotal movement of intermediate members 36, 37 about the axis of the hinge pins 40, 43. This must be done without restricting the pivotal movements about the various hinge pins too much. The aim is to create a greater tendency for the intermediate members 36, 37 to rotate about their hinge pins 40, 43 when the hinge plate 12 or 13 is rotated to, and from, the position shown in FIG. 15 to, and from, the position shown in FIG. 16, whilst keeping the intermediate members 36 or 37 stationary relative to the hinge plate that is being lifted or lowered. This ensures that the hinge pins 16 or 17 are lifted through an arcuate path to a position clear of the top of the base 11 and the top of portion 23 of hinge plate 13, to avoid the possibility the lifted hinge plate 12 or 13 jamming against the base 11 or the structure 21, 22 carried by the stationary hinge plate 12 or 13.

When the hinge plates 12, 13 together with the intermediate members 36, 37 are moved to, and from, the position shown in FIG. 15 to, and from, the position shown in FIG. 16 (i.e. from the 90° position to the 180° position) about the axis of the respective hinge pins 40 or 43, the hinge plates 12 or 13 start to rotate relative to the intermediate members 36, 37 about their respective pivots 16 or 17. This allows the raised hinge plate 12 or 13 to continue movement to the 180° position until it engages the top of the portion 23 of the stationary hinge plate 12 or 13.

Lowering of the raised hinge plate 12 or 13 from the 180° position shown in FIG. 16 to the 90° position shown in FIG. 15 is achieved by the raised hinge plate rotating first about the respective hinge pin 16 or 17 and then by the hinge plate 12 pulling the intermediate member 36, or 37 to cause it to rotate about its respective hinge pin 40 or 43.

This differential resistance could be provided by making the hinge pins 16 and 17 a slightly tighter fit than that of the hinge pins 40, 43 to provide more friction than the hinge pins 40 or 43. However this solution may be prone to accelerated wear over prolonged use of the hinge. A better solution may be to provide a torsion spring (not shown) on the axes of the hinge pins 16, 17 that acts between the hinge plate 12 or 13 and the respective intermediate member 36 or 37 to provide a stronger bias against rotation of the intermediate members 36, 37 about the axis of hinge pins 16 and 17 during the initial 90° movement of the raised hinge plate 12 or 13 than during the movement of the raised hinge plate from the position shown in FIG. 15 through the 90° to 180° movement of the hinge plate.

The operation of the hinge 10 shown in FIGS. 12 to 16 will now be explained in relation to lifting and rotating the hinge plate 12. As one lifts the hinge plate 12 upwards from the position shown in FIG. 14 towards the 90° position (shown in FIG. 15), the portion 23 of hinge plate 12 starts to pivot about the axis of the hinge pin 16 in the aligned holes 27. Initial rotation of the hinge plate 12 to the 90° position (shown in FIG. 15) takes place predominantly due to pivotal movement about the pivotal axis of the hinge pins 16.

Further lifting of the hinge plate 12 past the 90° position shown in FIG. 15, pulls the free ends of the fingers 36(a) of the intermediate member 36 upwards, causing the intermediate member 36 to start to rotate about the axis of the hinge pins 40. This effectively moves the coaxial hinge pins 16 bodily along an arcuate path. Once the coaxial hinge pins 16 are above the top of the base 11, the hinge pins 16 are carried bodily to a position where the fingers 36(a) extend upwardly (as shown in FIG. 16) and the flange 24 of the hinge plate 12 is moved to the position shown in FIG. 16 which is at 180° from the start position of FIG. 14. Rotation past the 180° is stopped by the top of the upstanding portion 23 of hinge plate 12 bearing against to top of the upstanding portion 23 of hinge plate 13.

Similar action is performed when lifting hinge plate 13 instead of hinge plate 12, but in this case, rotation of the hinge plate 13 takes place about the axis of the hinge pins 17, the ends of the fingers 37(a) are lifted, and the intermediate member 37 rotates about the axis of hinge pins 43 to lift the two hinge pins 17 along an arcuate path to a position above the end of the base 11 in a similar manner to that described above.

It will be appreciated that both hinge plates 12 and 13 can be moved simultaneously from the position shown in FIG. 14 through 90° to the position shown in FIG. 15, but only one of the hinge plates 12 or 13 at a time can be rotated through 180° to the position shown in FIG. 16 because the structures 21, 22 carried by the hinge plates 12 and 13 would collide with each other.

Referring to FIG. 17 there is shown a modification of the hinge of FIGS. 12 to 16 wherein the base 11 is provided with two slots 50(a), 50(b) similar to that described above in relation to FIG. 10. In each slot 50(a), 50(b) is located a sliding pivot 51(a), 51(b). The slots 50(a), 50(b) differ slightly from that shown in FIG. 10 in that each has a straight portion and an arcuate portion. Connected to each pivot 51(a) or 51(b) is a cranked arm 52, 53 which is pivotally connected to one of the hinge plates 12, 13. Both pivots 51(a) and 51(b) can be moved in unison to rotate the hinge plates 12, 13 through 90° but both hinge plates 12, 13 cannot be moved together past the 90° position simultaneously. Each hinge plate 12, 13 can be rotated individually to the 180° by moving one of the sliding pivots 51(a) or 51(b) relative to the other.

With regards to any of the hinges shown in FIGS. 6 to 10, or 17, instead of lifting the hinge plates 12 or 13 manually, an actuator 59 may be used to push or pull the third pivot 51, 51(a), or 51(b) along the slots 50, 50(a), 50(b) in the base 11. Two actuators 59 are shown schematically in FIG. 17 and may be in the form of a gas strut (similar to that used for opening a car boot door), or of the type that uses a captive nut (not shown) secured to the third pivot 51 that is mounted on a screw (not shown) that is driven by a small electric motor or stepping motor (not shown).

Referring to FIGS. 18 and 19 there is shown a further embodiment of the present invention where the base 11 is not mounted on fixed or moveable structure 20 but is shortened to coincide with the length of the upstanding portion 23 of the hinge plates 12, 13. The hinge 10 of FIG. 18 is shaped to fit within recesses provided in the confronting edges of hinged structures 21, 22 or, in an alternative arrangement, one of the recesses could be provided in fixed structure such as a door jamb 60. The hinge plates 12 and 13 each have a flange 24 for fixing the hinge 10 into the respective recess. The hinge 10 of FIGS. 18 and 19 has arms 52, 53 accommodated within a recess in the flat surfaces of the base 11. In operation of the hinge 10 of FIGS. 18 and 19 rotation of the hinged structure 21 relative to the door jamb 20 causes the arms 52, 53 push the base 11 so that it rotates about the respective pivot pin 16, 17 and carries the hinged structure 21 enabling it to swing through 180°. The hinge 10 of FIGS. 18 and 19 may incorporate actuators 57 similar to that shown in FIG. 11

In some applications of any of the hinges described above where movements of the hinged structures 22, 23 require to be damped, the actuators 57 and, or, 59 may be replaced by, or supplemented with, a damper (not shown). The damper may be, for example, a gas strut or hydraulic piston and cylinder. The function of such a damper would be to cushion the movement of the hinged structures 22, 23 as they are moved.

In some uses of the hinges of the present invention, two or more discrete hinges 10 may be spaced along a common axis with the bases 11 of each hinge 10 fixed to a common structure 20, and the hinge plates 12, 13 connected to common structures 21 or 22 respectively. An example of this use is where a pair of hinges 10 is used for each door (of a pair of doors) 21, 22 of a kitchen cabinet.

In some applications of the 90° hinges shown in FIGS. 1 to 19 there may be two or more hinges 10 spaced along a common axis with the bases 11 of each hinge fixed to a common structure 20, and some, or all, of the hinges may be linked together with common hinge pins 16 and 17 inserted through the aligned holes 14, 16, of all of the hinges 10 spaced along the common axis. An example of this use is where a pair of hinges is used for a pair of hinged extension flaps or leaves of a table where precision of location of each pair of hinges may be required.

In some applications of the 180° hinge shown in FIGS. 12 to 17 there may be two or more hinges 10 spaced along a common axis with the bases 11 of each hinge fixed to a common structure 20, and some or all of the hinges 10 may be linked together with common hinge pins 16 and 17 inserted through the aligned holes 27 of adjacent hinges 10 spaced along the common axis.

Hinges constructed in accordance with the present invention have numerous uses that cannot be met with prior known hinges. Examples of such uses are shown in FIGS. 20 to 27.

Referring to FIGS. 20 to 23 there is shown a table 60 that incorporates a pair of hinges 10 constructed in accordance with any one of FIG. 1 to 20. The table comprises a table stand 61 comprising base 62 and two vertical hollow legs 63. Two hinges 10 are mounted on a common structural member 20 that has a central pivot 64 that locates in a horizontal carriage 65 that can be raised and lowered vertically relative to the legs 63.

The table top comprises a two leaves 66 that are mounted on hinge plates 12, 13 of hinges 10. The bases 11 of the hinges 10 are mounted on the common member 20. The hinges 10 are manually operated hinges of the type shown in FIGS. 1 to 6.

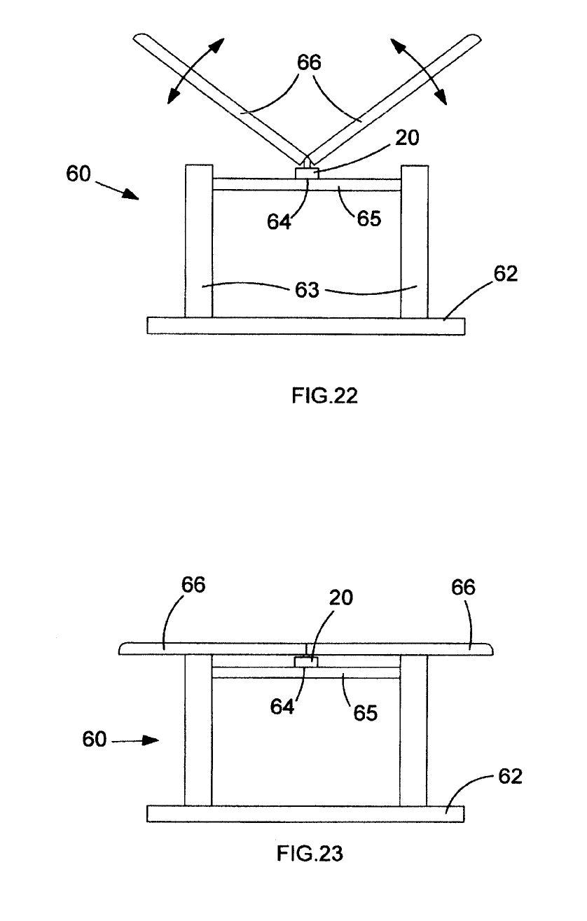

In operation, the folded leaves 66 of the table top are stowed between the legs 63 as shown in FIG. 20 and are raised to the position shown in FIG. 21 by lifting the carriage 65 until it lies level with the tops of the legs 63. The structural member 20 is then rotated relative to the carriage 65 about a vertical axis to bring the fold line of the leaves 66 at right angles to its original position as shown in FIG. 22. The leaves 66 are then unfolded to the position shown in FIG. 23 and rest on the top of the legs 63. By reversing the steps shown in FIGS. 20 to 23 the leaves are stowed in the space between the legs 63.

The table just described can be operated manually by lifting the leaves 66 and opening them up as described. If desired the table 60 could be operated electrically by installing a screw drive lifting drive mechanism (not shown) in each leg 63 that lifts the carriage 65 vertically. In this case the hinges 10 are provided with electrically driven motors that operate actuators 57 and/or 59 (not shown in FIGS. 20 to 23 but as described above) to move the hinge plates 12, 13 appropriately.

Referring to FIGS. 24 to 27 there is shown a second folding table 70 that incorporates hinges of the type shown in any one of FIGS. 1 to 6. Here again the hinges 10 are manually operated but could be of the type that incorporate actuators 57 and or 59 as described above.

The base of the table is in the form of a hollow pod 71 which is approximately 850 mm high that is mounted on a flat base 72. The pod 71 is of oval cross section that measures approximately 900 mm along a major axis and 200 mm along a minor axis. The table top is best seen in FIG. 27 and comprises four table flaps or leaves 76 to 79 arranged in two pairs. Each leaf 76 to 79 has a major axis of approximately 800 mm and a minor axis of approximately 500 mm so that when opened in the position shown in FIG. 27 the table is generally rectangular with rounded corners with a major axis of 1600 mm and a minor axis of 1000 mm. The leaves 76 and 77 of one pair of leaves are connected together along their major axes by single a piano hinge 80 that is mounted on the underside of the leaves 76 and 77. The piano hinge 80 is not constructed in accordance with the present invention.

The leaves of the pair of leaves 76 and 78 and the leaves of the pair of leaves 77, 79 are connected together along their minor axes by hinges 10 constructed in accordance with the present invention. The confronting edges of the leaves 78 and 79 at the interface between the leaves 78 and 79 when they are in the horizontal position shown in FIG. 27, are not interconnected by hinges but have co-operating hidden dowels 74 that locate in cooperating bores (not shown) in the edges of the leaves 78 and 79.

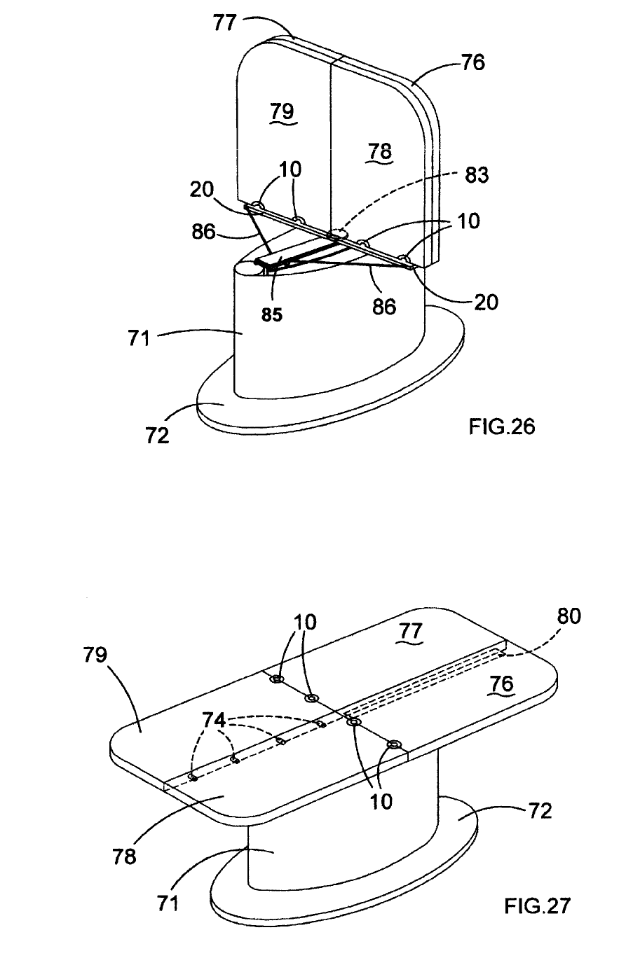

A metal or wooden member 20 is provided that has two halves pivotally mounted on a central pivot 83 (see FIG. 26). The central pivot 83 is mounted on a slider that is free to slide along the length of a horizontal carriage 85 that extends along the major axis of the pod 71. The carriage 85 is mounted on a vertical lifting mechanism (not shown) operated by a lifting actuator (not shown) located within the pod 71. Spaced along each half of the member 20 are two hinges 10 constructed in accordance with the present invention, each with its base 11 pivotally mounted on the member 20.

When the leaves 76 to 79 are in the position shown in FIGS. 24 and 25 the member 20 is folded and lies with the pivot 83 to the right as seen in FIGS. 24 and 25. Connected between each half of the member 20 is a tie bar 86 that is anchored on the carriage 85. As will be explained later when the pivot 83 is caused to slide along the carriage 85 from the left towards the right (i.e. from the position shown in FIG. 25 to that shown in FIG. 26) the tie bars 86 pull on the two halves of the member 20 causing it to unfold about the pivot 83, so that the member 20 extends across the table top in a direction at right angles to its original folded position as shown in FIG. 26. In this position the pivot 83 aligns with the pivotal axis of the piano hinges 85, 86 as will be explained later.

The leaves 76 to 79 of the table top are folded and stored in the pod 71 as shown in FIG. 24, and when in this position, a display panel (not shown) can be mounted on the outside of the pod and raised to hide the tops of the folded leaves. To understand the folding action of the table top it is best to consider the open table top as shown in FIG. 26. The leaves 76 to 79 are first folded about their minor axes in unison to the position shown in FIG. 26. The member 20 is then caused to fold about pivot 83 by grasping the two pairs of folded leaves 76 to 79 in an action similar to closing an open book to bring the leaves 76 and 77 by rotating them about the axis of the piano hinge 80. This action causes the dowels 74 to disengage the bores in the confronting edges between the leaves 78 and 79, and simultaneously rotates all the leaves 76 to 79 about the piano hinge 80 to the position shown in FIG. 25. During this folding action the tie bars 86 causes the pivot 83 to move from right to left (as seen in FIG. 26) along the carriage 85 to the position shown in FIG. 25. In this position, the folded leaves 76 to 79 lie side by side and extend vertically upwards as shown in FIG. 25. With the leaves completely folded to the position shown in FIG. 25, the folded leaves are lowered into the pod 71.

To open up the table the four leaves 76 to 79 are raised out of the pod from the position shown in FIG. 24 to the position shown in FIG. 25. The table leaves 76 to 79 are then unfolded by opening the folded leaves simultaneously by rotating the leaves about the pivotal axis of the piano hinge 80. This causes the free ends of the structural member 20 (on which the bases 11 of the hinges 10 are mounted) to be pulled open by the tie bars 86, and causes the dowels 74 to engage in the bores at the interface between the leaves 78 and 79. This action is very much like opening a book and pulls the pivot 83 spine formed by the piano hinge 80 to the right of FIG. 24 to the centre of the pod 71, and straightens the structural member 20 so that it lies across the minor axis of the pod 71 (FIG. 26). The folded leaves 76 to 79 are simultaneously lowered so that they assume a horizontal flat position resting on the top of the pod 71.

The manually operated hinges 10 could be replaced by those fitted with actuators 57 and/or 59 as described above, and the carriage may be raised and lowered manually or electrically (by providing electric motor driven lifting mechanisms at each end of the carriage) or by means of gas operated struts.

It will be appreciated that the action of unfolding and folding of the leaves of the tables shown in FIGS. 21 to 27 would be totally impossible without the use of hinges 10 of the present invention.

In many applications the majority of the hinges 10 are mainly hidden from view with only the tops of the bases 11 of the hinges and tops of portions 23 visible. By making the components of the hinge in aesthetically pleasing materials, such as high quality gold, silver, bronze, brass, or stainless steel, with precision tolerances, the visible parts of the hinge 10 can form part of the aesthetic features of the table top or other furniture in which the hinge is used.

If desired, the base 11 of the above mentioned hinges 10 of the tables described could be made of two or more parts which allow one part to rotate relative to the other about an axis extending along the length of the base 11. Such a hinge would allow the parts carried by the hinge plates 12 and 13 not only to pivot about their respective hinge pins, but would allow them to swivel bodily about the centreline axis of the base 11.

In another use of the hinge 10 of FIGS. 1 to 3 the base 11 is mounted on the body of a mobile telephone or palmtop computer, a first screen is mounted on a hinge plate 12, and a second screen (or keypad) is mounted on a hinge plate 13. This embodiment provides a mobile telephone with the capabilities of extending the visible screen to a “wide screen” display by opening out two screens in which a single image is made up of two combined images. If the hinge is one where the base 11 may rotate about its axis, it would be possible to open two screens carried by the hinge plates 12 and 13 in a similar way to that of a conventional clamshell type of telephone, and then rotate the screens bodily through an angle of 90° about the longitudinal axis of the base to a landscape or “open book” position.

1-28. (canceled)

29. A hinge comprising an elongate base (11) and first and second hinge plates (12,13) that constitute or carry hinged structures (21, 22) pivotally mounted on said base, wherein the base has two parallel spaced holes (14,15, 31, 32) for receiving two parallel spaced pivot pins (16, 17) extending at right angles to the length of the base (11) across the width of the base, each of the hinge plates (12, 13) has an upstanding portion (23) extending in a direction extending along the length of the base (11) that encompasses a part of the perimeter of the base, and each hinge plate (12, 13) has two aligned holes (27) that align with one of the holes (14, 15) in the base (11) for receiving one of said pivot pins (16, 17) thereby enabling each hinge plate (12,13) to pivot relative to the base (11) about a respective one of the pivot pins (14,15).

30. A hinge according to claim 29 wherein the cross sectional shape of the base (11) is selected from a circular shape, an oval shape, a generally rectangular shape, or a generally square shape, and the upstanding portion (23) has a surface facing the perimeter of the base (11) that is of a complementary shape to the cross sectional shape of the base.

31. A hinge according to claim 29 wherein the length of the base (11) and the length of the upstanding portion (23) measured from the plane of the flange means (24) of each hinge plate (12, 13) matches a predetermined thickness of the hinged structure (21, 22).

32. A hinge according to claim 29 wherein the two holes (27) in each hinge plate (12, 13) are provided in the flange means (24) of the hinge plate (12, 13).

33. A hinge according to claim 29 wherein the base (11) has fixing means (18) for enabling the hinge (10) to be mounted on a fixed or moveable structure (20).

34. A hinge according to claim 33 wherein the fixing means (18) is selected from a screw threaded bore (18) for receiving a screw threaded stud, or a spigot (18) with a “Fir Tree” fixing.

35. A hinge according to claim 29 wherein the base (11) has two spaced flanges (30) that project from an end of the base in a direction that extends along a longitudinal axis of the base (11), and the two spaced parallel holes (31, 32) in the base (11) extend through the two flanges (30) of the base (11) in a direction normal to a longitudinal axis of the base (11), the hinge (10) has two intermediate members (36, 37) each of which has long fingers (36(a), 37(a) respectively) and short fingers (36(b), 37(b) respectively), said intermediate members (36, 37) being assembled relative to each other with their fingers (36(a), 36(b), 37(a), 37(b)) interdigitated with each other and with the flanges (30) of the base (11), the long fingers 36(a) of a first of the intermediate members (36) having a first set of aligned holes (39) co-axially aligned with a first of the holes (31) in the flanges (30) of the base (11), the short fingers (36(b)) of the first intermediate member (36) having aligned holes (41) coaxially aligned with the aligned holes (27) in the upstanding portion (23) of the first of the hinge plates (12, 13), the long fingers (37(a)) of a second of the intermediate members (37) having a first set of aligned holes (42) coaxially aligned with the aligned holes (32) of the holes (31, 32) in the flanges (30) of the base (11), the short fingers (37(b)) of the second member (37) having aligned holes (44) that align with the holes (27) in the upstanding portion (23) of the second of the hinge plates (12, 13), the first set of hinge pins (16) being inserted though the holes (41) in the short fingers (36(b)) of the member (36) and in the holes (27) of the upstanding portion (23), the second set of hinge pins (17) being inserted in the holes (44) of the short fingers 37(b)) of the member (37) and the aligned holes (27) in the upstanding portion (23) of the second of the hinge plates (12, 13), a third set of hinge pins (40) inserted in the holes (39) in the long fingers (36(a)) of the intermediate member (36) and the aligned holes (31) in the flanges (30) of the base (11), and a fourth set of hinge pins (43) inserted in the holes (42) in the long fingers (37(b) of the intermediate member (37) and the aligned holes (32) in the flanges (30) of the base (11).

36. A hinge according to claim 35 wherein a spring is provided between the upstanding portions (23) and the intermediate members (36, 37) to provide more resistance to pivotal movement about the hinge pins (16, 17) in the holes (27) of the upstanding portions (23) than about the hinge pins (40, 43) in the long fingers (36(a), 37(a)) at least during an initial movement of the hinge plates (12, 13) relative to the intermediate members (36, 37).

37. A hinge according to claim 29 wherein the base (11) is provided with a slot (50, 50(a), 50(b)) in which is located a sliding pivot (51, 51(a), 51(b)), and the sliding pivot is connected to at least one of the hinge plates (12, 13) by means of an arm (52, 53) that acts on the hinge plate (12, 13) when the sliding pivot (51, 51(a), 51(b)) moves along the slot (50, 50(a), 50(b)) to pivot the respective hinge plate (12, 13) relative to the base (11).

38. A hinge according to claim 37 wherein there are two slots (50(a), 50(b)) in the base (11) each with a sliding pivot (51(a), 51(b)) connected to one of the hinge plates (12, 13).

39. A hinge according to claim 37 wherein an actuator (57, 59) is provided for moving the or each sliding pivot (51, 51(a), 51(b)) along its respective slot (50, 50(a), 60(b)) in the base (11).

40. A hinge according to claim 29 wherein an actuator (57, 59) is provided on one or more of the hinge plates (12, 13) that acts on the base (11) to move the hinge plate (12, 13) relative to the base (11).

41. A hinge according to claim 37 wherein a damper is provided for dampening movement of the or each sliding pivot (51, 51(a), 51(b)) as it moves along its respective slot (50, 50(a), 50(b)) in the base (11).

42. A hinge according to claim 29 wherein a damper is provided on one or more of the hinge plates (12, 13) that acts on the base (11) to dampen movement of the hinge plate (12, 13) as it moves relative to the base (11).

43. A hinge according to claim 29 wherein the base (11) is provided with one or more guide slots (50, 50(a), 50(b)) in which a sliding pivot (51, 51(a), 51(b)) slides and there is provided an arm (52, 53) pivotally connected to the sliding pivot and to at least one of the hinge plates (12, 13).

44. A table (60, 70) having hinged leaves (66, 76 to 79) incorporating one or more hinges (10) constructed in accordance with claim 29.
